(19) United States
(12) Patent Application Publication
(10) Pub. No.: US 2026/0269269 A1
(43) Pub. Date: Sep. 10, 2026

(54) ALKALINE STORAGE BATTERY

(71) Applicant: Panasonic Intellectual Property Management Co., Ltd., Osaka (JP)

(72) Inventors: TOSHIYUKI MUNESADA, Osaka (JP); AKIKO OKABE, Osaka (JP); RYUKI KUROOKA, Osaka (JP)

(21) Appl. No.: 19/165,615

(22) PCT Filed: Feb. 28, 2024
(86) PCT No.: PCT/JP2024/007243

§ 371 Date: Sep. 16, 2025

(30) Foreign Application Priority Data
Mar. 28, 2023 (JP) 2023-051844

(51) Int. Cl. H01M 4/62; H01M 4/36; H01M 4/52; H01M 10/34

(52) U.S. Cl. CPC H01M 4/628; H01M 4/366; H01M 4/52; H01M 10/345

(57) ABSTRACT

The disclosed alkaline storage battery includes a positive electrode including a positive electrode mixture layer containing, as a positive electrode active material, a nickel compound having a surface at least partially coated with a cobalt compound, and a negative electrode including a negative electrode mixture layer containing a hydrogen storage alloy. The positive electrode mixture layer includes two surface layers and an inner layer sandwiched between the two surface layers. Each of the two surface layers and the inner layer contains a positive electrode active material. The thickness Ts of each of the two surface layers is 20 μm or more. The ratio Ts/Tp of the thickness Ts to the thickness Tp of the positive electrode mixture layer is in the range of 0.03 to 0.20. Each of the two surface layers contains a titanium compound and a magnesium compound. The inner layer contains a compound of at least one element X selected from the group consisting of Ti, Yb, Y, Nb, and W. The two surface layers and the inner layer contain the above elements in a predetermined range.

### BACKGROUND

### 1. Technical Field

The present disclosure relates to an alkaline storage battery.

### 2. Description of the Related Art

Alkaline storage batteries such as nickel-metal hydride storage batteries are used in various applications. Various proposals have been made for alkaline storage batteries.

Claim 1 of Patent Literature 1 (JP 2015-130249 A) describes “a positive electrode for an alkaline storage battery, the positive electrode including a conductive support and a positive electrode mixture adhering to the support, the positive electrode mixture including a positive electrode active material containing a nickel oxide, the positive electrode mixture further including a first additive, a second additive, and a third additive, the first additive being a compound containing tungsten, the second additive being a compound containing titanium, and the third additive containing at least one selected from the group consisting of yttrium, ytterbium, calcium, and zinc”.

Claim 1 of Patent Literature 2 (JP 2020-43010 A) describes “a positive electrode for an alkaline secondary battery, the positive electrode including a positive electrode substrate and a positive electrode mixture supported on the positive electrode substrate, wherein the positive electrode mixture includes a nickel hydroxide as a positive electrode active material, a positive electrode additive, and a conductive material, the positive electrode additive includes a first additive and a second additive, the total amount of the first additive and the second additive is 0.1 parts by mass or more and 2.5 parts by mass or less with respect to 100 parts by mass of the nickel hydroxide, the mass ratio of the first additive and the second additive is X:Y=1:0.2 to 5, where X is the mass of the first additive and Y is the mass of the second additive, the resistivity of the positive electrode mixture after activation treatment is 1Ω·m or more and 10Ω·m or less, the nickel hydroxide includes at least one of nickel oxyhydroxide and nickel hydroxide, the first additive is yttrium oxide, and the second additive includes at least one of niobium oxide and titanium oxide”.

Claim 1 of Patent Literature 3 (JP-A-2001-250529) describes “an alkaline secondary battery characterized in that an inorganic substance is present close to the positive electrode of the separator or in the positive electrode”.

### CITATION LIST

### Patent Literature

Patent Literature 1: Unexamined Japanese Patent Publication No. 2015-130249
Patent Literature 2: Unexamined Japanese Patent Publication No. 2020-43010
Patent Literature 3: Unexamined Japanese Patent Publication No. 2001-250529

### SUMMARY

Currently, there is an increasing demand for batteries that can be used in high-temperature environments, such as vehicle-mounted batteries. However, in a high-temperature environment, the performance of the alkaline storage battery is likely to deteriorate.

One aspect of the present disclosure relates to an alkaline storage battery. The alkaline storage battery comprises a positive electrode including a positive electrode mixture layer containing, as a positive electrode active material, a nickel compound having a surface at least partially coated with a cobalt compound, and a negative electrode including a negative electrode mixture layer containing a hydrogen storage alloy, wherein the positive electrode mixture layer includes two surface layers and an inner layer sandwiched between the two surface layers, each of the two surface layers and the inner layer contains the positive electrode active material, a thickness Ts of each of the two surface layers is 20 μm or more, a ratio Ts/Tp of the thickness Ts to a thickness Tp of the positive electrode mixture layer is in a range of 0.03 to 0.20, each of the two surface layers contains a titanium compound and a magnesium compound, the inner layer contains a compound of at least one element X selected from the group consisting of Ti, Yb, Y, Nb, and W, a ratio Mst/Msc of a mass Mst of titanium contained in each of the two surface layers to a mass Msc of cobalt contained in each of the two surface layers is in a range of 0.04 to 0.60, a ratio Msm/Msc of a mass Msm of magnesium contained in each of the two surface layers to the mass Msc is in a range of 0.01 to 0.30, a ratio Mix/Mic of a total mass Mix of the at least one element X contained in the inner layer to a mass Mic of cobalt contained in the inner layer is in a range of 0.04 to 0.60, and a ratio Mim/Mic of a mass Mim of magnesium contained in the inner layer to the mass Mic is 0.001 or less.

In the present disclosure, an alkaline storage battery in which high performance (e.g., charging efficiency and storage characteristics) can be maintained even in a high-temperature environment (for example, 85° C.) is obtained.

### BRIEF DESCRIPTION OF DRAWINGS

FIG. 1 is a partially exploded perspective view schematically illustrating an alkaline storage battery according to an embodiment.

FIG. 2 is a cross-sectional view schematically illustrating a structure of an example of a positive electrode.

FIG. 3 is a table showing evaluation results of the alkaline storage battery according to the embodiment.

FIG. 4 is a table showing evaluation results of the alkaline storage battery according to the embodiment.

FIG. 5 is a table showing evaluation results of the alkaline storage battery according to the embodiment.

FIG. 6 is a table showing evaluation results of the alkaline storage battery according to the embodiment.

FIG. 7 is a table showing evaluation results of the alkaline storage battery according to the embodiment.

FIG. 8 is a table showing evaluation results of the alkaline storage battery according to the embodiment.

FIG. 9 is a table showing evaluation results of the alkaline storage battery according to the embodiment.

FIG. 10 is a table showing evaluation results of the alkaline storage battery according to the embodiment.

### DESCRIPTION OF EMBODIMENT

Hereinafter, an embodiment according to the present disclosure will be described with examples, but the present disclosure is not limited to the examples described below. In the following description, specific numerical values and materials may be exemplified, but other numerical values and other materials may be applied as long as the invention according to the present disclosure can be implemented. In the present specification, the expression “numerical value A to numerical value B” includes the numerical value A and the numerical value B, and can be read as “numerical value A or more and numerical value B or less”. In the following description, when lower limits and upper limits of numerical values relating to specific physical properties and conditions are exemplified, any of the exemplified lower limits and any of the exemplified upper limits can be arbitrarily combined as long as the lower limit is not equal to or greater than the upper limit.

### (Alkaline Storage Battery)

The alkaline storage battery according to the present embodiment may be hereinafter referred to as an “alkaline storage battery (B)”. The alkaline storage battery (B) includes a positive electrode including a positive electrode mixture layer containing, as a positive electrode active material, a nickel compound having a surface at least partially coated with a cobalt compound, and a negative electrode including a negative electrode mixture layer containing a hydrogen storage alloy. The positive electrode mixture layer includes two surface layers and an inner layer sandwiched between the two surface layers. Each of the surface layers and the inner layer contains the positive electrode active material. A thickness Ts of each of the two surface layers is 20 μm or more. A ratio Ts/Tp of the thickness Ts to the thickness Tp of the positive electrode mixture layer is in the range of 0.03 to 0.20. Each of the two surface layers contains a titanium compound and a magnesium compound. The inner layer contains a compound of at least one element X selected from the group consisting of Ti, Yb, Y, Nb, and W. A ratio Mst/Msc of a mass Mst of titanium contained in each of the two surface layers to a mass Msc of cobalt contained in each of the two surface layers is in a range of 0.04 to 0.60. A ratio Msm/Msc of the mass Msm of magnesium contained in each of the two surface layers to the mass Msc is in the range of 0.01 to 0.30. A ratio Mix/Mic of the total mass Mix of the at least one element X contained in the inner layer to the mass Mic of cobalt contained in the inner layer is in the range 0.04 to 0.60. A ratio Mim/Mic of a mass Mim of magnesium contained in the inner layer to a mass Mic is 0.001 or less.

The thickness and/or composition ratio of one surface layer may be the same as or different from the thickness and/or composition ratio of the other surface layer. However, each surface layer satisfies the above-described conditions regarding the thickness and the composition ratio of the surface layer.

By using a porous current collector (e.g., foamed nickel) as the positive electrode current collector, one continuous inner layer can be formed. On the other hand, when a sheet-shaped positive electrode current collector having no hole is used, the positive electrode mixture layer is formed on both surfaces thereof. The positive electrode mixture layer includes a first positive electrode mixture layer formed on one surface of the positive electrode current collector and a second positive electrode mixture layer formed on the other surface of the positive electrode current collector, and the inner layer includes a first inner layer formed on one surface of the positive electrode current collector and a second inner layer formed on the other surface of the positive electrode current collector. In this case, the thickness Tp of the positive electrode mixture layer is the sum of the thickness of the first positive electrode mixture layer and the thickness of the second positive electrode mixture layer. The thickness of the inner layer is the sum of the thickness of the first inner layer and the thickness of the second inner layer. The composition of the inner layer is a composition when the first inner layer and the second inner layer are considered as one layer.

As a positive electrode active material of an alkaline storage battery, a nickel compound coated with a cobalt compound functioning as a conductive material may be used. As described above, Patent Literatures 1 and 2 disclose techniques for adding an additive to a positive electrode. When oxygen generation in the positive electrode is suppressed by adding the additive to the positive electrode, the surface of the positive electrode becomes a hydrogen atmosphere due to hydrogen released from the hydrogen storage alloy of the negative electrode. When the battery in such a state is used at a high temperature (in particular, 85° C. or higher) for a long period of time, the cobalt compound on the surface of the positive electrode active material is reduced by hydrogen. A part of the reduced cobalt compound is eluted as ions into the electrolytic solution and moves to the separator or the negative electrode. As a result, the conductivity of the surface of the positive electrode active material is decreased, and battery characteristics are decreased.

As a result of studies, the present inventors have found that an alkaline storage battery with high performance (e.g., charging efficiency and storage characteristics) can be maintained even in a high-temperature environment (for example, 85° C.) can be obtained by using the above configuration. The present disclosure is based on this new finding.

The reason why the high effect can be obtained by the above configuration is not clear at present. However, the following can be considered. It is considered that a trace amount of the titanium compound and the magnesium compound in the positive electrode mixture is dissolved in the electrolytic solution and deposited on the cobalt compound (conductive material) on the surface of the positive electrode active material, thereby suppressing the elution of the cobalt compound. This effect was not obtained by the addition of only the titanium compound and the addition of only the magnesium compound. This effect was obtained by adding the titanium compound and the magnesium compound to the positive electrode mixture at a predetermined ratio.

Examples of the titanium compound include titanium oxide (such as TiO₂), titanium oxyhydroxide (TiO(OH)₂), and titanium fluoride (TiF₄). The titanium compound may be a compound containing no metal element other than titanium.

Examples of the magnesium compound include oxides (MgO), hydroxides (Mg(OH)₂), halides thereof, and various salts thereof. Examples of the halide include fluoride (MgF₂). Examples of salts include carbonates (MgCO₃) and phosphates (Mg₃(PO₄)₂). The magnesium compound may be a compound containing no metal element other than magnesium.

The inner layer contains a compound XC of at least one element X selected from the group consisting of Ti, Yb, Y, Nb, and W. When the inner layer contains the compound XC, a high effect is obtained as shown in Examples. It is considered that this is because oxygen generation in the positive electrode is suppressed by the addition of the compound XC. As the compound XC, a compound that can exist relatively stably in the positive electrode mixture can be used. Examples of the compound XC include an oxide of the element X, a hydroxide of the element X, a halide of the element X, and a salt of the element X. The compound XC may be a compound shown in Examples.

A preferred example of the compound XC is a titanium compound. For example, the compound XC may be a titanium oxide (such as TiO₂) and/or a titanium oxyhydroxide (TiO(OH)₂).

The ratio Mix/Mic of the total mass Mix of the at least one element X contained in the inner layer to the mass Mic of cobalt contained in the inner layer is in the range 0.04 to 0.60. When the ratio Mix/Mic is in this range, a high effect is obtained as shown in Examples. By increasing the ratio Mix/Mic, the charging efficiency at high temperatures can be increased. By lowering the ratio Mix/Mic, a decrease in discharge capacity at high temperature can be suppressed. The ratio Mix/Mic is greater than or equal to 0.04 and may be greater than or equal to 0.10 or greater than or equal to 0.30. The ratio Mix/Mic is 0.60 or less, and may be 0.30 or less.

A ratio Mim/Mic of a mass Mim of magnesium contained in the inner layer to a mass Mic of cobalt contained in the inner layer is 0.001 or less. By setting the ratio Mim/Mic to be 0.001 or less, a high effect is obtained as shown in Examples. In a preferred example, the inner layer is substantially free of magnesium.

A ratio Mst/Msc of a mass Mst of titanium contained in one surface layer to a mass Msc of cobalt contained in the surface layer is in a range of 0.04 to 0.60. The ratio Msm/Msc of the mass Msm of magnesium contained in one surface layer to the mass Msc of cobalt contained in the surface layer is in the range of 0.01 to 0.30. By adding the titanium compound and the magnesium compound to the surface layer so as to satisfy these ranges, a high effect can be obtained as shown in Examples.

The thickness Tp of the positive electrode mixture layer is not particularly limited, and is selected depending on the application of the battery. The thickness Tp may be 100 μm or more, and may be 500 μm or more. The thickness Tp may be 1,000 μm or less, or 500 μm or less.

The thickness Ts of one surface layer is 20 μm or more. The total thickness of the two surface layers is 40 μm or more. By setting the thickness Ts to be 20 μm or more, the influence of hydrogen reaching from the negative electrode can be sufficiently suppressed.

The ratio Ts/Tp of the thickness Ts to the thickness Tp of the positive electrode mixture layer is in the range of 0.03 to 0.20. When the ratio Ts/Tp is 0.03 or more, the influence of hydrogen reaching from the negative electrode can be sufficiently suppressed. On the other hand, when the surface layer having a high ratio of the titanium compound and the magnesium compound is too thick, the discharge capacity decreases. By setting the ratio Ts/Tp to be 0.20 or less, a decrease in discharge capacity can be suppressed.

The ratio Ts/Tp is 0.03 or more, and may be 0.05 or more, or 0.10 or more. The ratio Ts/Tp is 0.20 or less, and may be 0.15 or less, or 0.10 or less. By setting the ratio Ts/Tp to 0.10 or less, a high effect is obtained as shown in Examples.

The surface layer may contain a hydroxide of at least one element A selected from the group consisting of Ca and Ba. In other words, the surface layer may contain at least one hydroxide selected from the group consisting of calcium hydroxide and barium hydroxide. In this configuration, as shown in the embodiment, a high effect can be obtained. The ratio Msa/Msc of the mass Msa of the at least one element A contained in the surface layer to the mass Msc of cobalt contained in the surface layer may be in the range of 0.01 to 0.30 (for example, in the range of 0.05 to 0.20).

The surface layer may include a compound of at least one element Z selected from the group consisting of W, Yb, Y, and Nb. In this configuration, as shown in Examples, a high effect can be obtained. The ratio Msz/Msc of the mass Msz of the at least one element Z contained in the surface layer to the mass Msc of cobalt contained in the surface layer may be in the range of 0.04 to 0.60 (for example, in the range of 0.10 to 0.30).

The equilibrium hydrogen pressure of the hydrogen storage alloy of the negative electrode mixture layer may be 0.15 MPa or less at 45° C. In this configuration, as shown in Examples, a decrease in discharge capacity during high-temperature storage can be suppressed. The equilibrium hydrogen pressure is an equilibrium hydrogen pressure at the hydrogen storage amount H/M=0.5.

### (Method for Producing Positive Electrode)

An example of a method for producing the positive electrode of the alkaline storage battery (B) will be described below. However, the positive electrode of the alkaline storage battery (B) may be produced by a method other than the method described below. The matters described for the positive electrode of the alkaline storage battery (B) can be applied to the following production method, and thus redundant description may be omitted.

### (1) First Method for Producing Positive Electrode (PM1)

The first production method (PM1) includes a step (i) and a step (ii) in this order. First, in the step (i), a first sheet to be the surface layer and a second sheet to be the inner layer are formed. The first sheet can be formed by preparing a first paste by mixing the components of the surface layer and a dispersion medium, and then applying and drying the first paste in layers. The second sheet can be formed by preparing a second paste by mixing the components of the inner layer and a dispersion medium, and then applying and drying the second paste in layers. The ratio of the components of the surface layer and the inner layer is determined depending on the ratio of the components of each paste. Therefore, the components of each paste and the thickness of each sheet are selected so as to satisfy the above-described conditions.

The dispersion medium is not particularly limited, and a known dispersion medium (for example, water) may be used. At least the second sheet includes a current collector (e.g., foamed nickel). Both the first sheet and the second sheet may comprise formed nickel. Each sheet can be formed, for example, by applying a paste to the current collector and then drying the paste. Each sheet may be pressed as necessary.

In the step (ii), the formed first sheet and second sheet are overlapped and pressed to be integrated. For example, one second sheet is inserted between two first sheets and they are pressed. Thus, the positive electrode can be formed. In the production method (PM1), the above steps are preferably performed so that the density of the positive electrode mixture and the distribution of the foamed nickel (current collector) are substantially constant in the entire positive electrode. An example of the production method (PM1) will be described in Experiment 1, which will be described later.

### (2) Second Method for Producing Positive Electrode (PM2)

The second production method (PM2) includes the step (I) and the step (II) in this order. In the step (I), a positive electrode precursor to be a positive electrode is formed. The method for forming the positive electrode precursor is not particularly limited, and the positive electrode precursor can be formed by the same method as that for a general positive electrode. In one example of the step (I), a paste is prepared by mixing the components of the inner layer and a dispersion medium. Next, the paste is applied to a positive electrode current collector and then dried to form a positive electrode precursor.

In the step (II), a liquid containing a compound necessary for forming the surface layer is applied to the surface of the formed positive electrode precursor and then dried. At this time, the concentration of the compound in the surface layer and the thickness of the surface layer can be adjusted by adjusting the concentration and amount of the liquid. A portion into which the compound in the applied liquid does not permeate becomes the inner layer. After drying the applied paste in the step (I) or after drying the applied liquid in the step (II), the positive electrode precursor is pressed as necessary. As described above, the positive electrode is formed. In the production method (PM2), the paste and the liquid are prepared so as to form the inner layer and the surface layer described above.

An example of the production method (PM2) will be described below. First, a paste is prepared by mixing a positive electrode active material, titanium oxide, carboxymethyl cellulose (CMC), and pure water. As the positive electrode active material, nickel hydroxide having a surface which is at least partially coated with a cobalt compound is used. Next, the paste is applied to a positive electrode current collector and then dried to form a positive electrode precursor.

Next, a liquid in which magnesium hydroxide powder is dispersed in pure water is prepared. Next, the liquid is applied to the surface of the positive electrode precursor and then dried, and the positive electrode precursor further is pressed. Thus, the positive electrode is manufactured.

As described later, the positive electrode of the alkaline storage battery (B) may be formed by impregnating the two surface layers with a predetermined compound in the assembled battery.

### (Method for Manufacturing Alkaline Storage Battery (B))

An example of a method for producing the alkaline storage battery (B) will be described below. Since the matters described for the alkaline storage battery (B) can be applied to the following production method, redundant description may be omitted.

### (1) First Production Method (BM1)

In the first production method (BM1), an alkaline storage battery (B) is produced using the positive electrode described above. The first production method (BM1) may include the production method (PM1) or the production method (PM2) of the positive electrode. The steps other than the method for producing the positive electrode are not particularly limited, and steps used in known production methods may be used. For example, first, an electrode group including a positive electrode, a negative electrode, and a separator is produced. Thereafter, the electrode group and the electrolyte solution are housed in an outer package to obtain the alkaline storage battery (B). When the electrode group is a wound electrode group, the electrode group can be formed by winding the positive electrode, the negative electrode, and the separator such that the separator is disposed between the positive electrode and the negative electrode.

### (2) Second Production Method (BM2)

In the second production method (BM2), the two surface layers of the positive electrode is formed in the battery. The second production method (PM2) includes a step (1) and a step (2) in this order. In the step (1), a battery is assembled according to a conventional method. However, the entire positive electrode mixture layer is formed with the components and the composition ratio of the inner layer described above. The method for forming the positive electrode in the battery is not limited, and the positive electrode may be formed by a known method.

In the step (2), a compound present outside the positive electrode is moved to the surface of the positive electrode mixture layer to form a part of the positive electrode mixture layer as the two surface layers. The area where the compound did not move becomes the inner layer. For example, by using a negative electrode containing Mg and performing a predetermined treatment, Mg in the negative electrode can be moved to the surface of the positive electrode mixture layer. However, in order to move Mg in the negative electrode to the surface of the positive electrode mixture layer, it is necessary to perform a predetermined treatment. It is difficult to manufacture the alkaline storage battery (B) by a normal production method in which a predetermined process is not performed.

An example of the production method (BM2) will be described below. The positive electrode is produced by the following procedure. First, nickel hydroxide powder, titanium oxide powder, carboxymethyl cellulose, and pure water are mixed to prepare a paste. The paste is applied to a current collector, dried, and rolled to obtain a positive electrode.

An electrode group is produced using the obtained positive electrode, a negative electrode, and a separator. When the electrode group is a wound electrode group, the electrode group can be formed by winding the positive electrode, the negative electrode, and the separator such that the separator is disposed between the positive electrode and the negative electrode.

As the negative electrode, a negative electrode containing Mg is used. For example, the negative electrode mixture layer may be formed using a hydrogen storage alloy containing Mg. Alternatively, a negative electrode mixture layer containing a hydrogen storage alloy and magnesium hydroxide may be used as the negative electrode mixture layer. In one example, the mass of magnesium hydroxide is 1% of the mass of the hydrogen storage alloy.

Next, the battery is assembled by housing the electrode group and the electrolyte solution in an outer package. In the production method (BM2), Mg (Mg compound) in the negative electrode is moved to the surface of the positive electrode mixture layer by performing a predetermined activation step after the battery is assembled. As a result, the surface of the positive electrode mixture layer becomes the above-described surface layer. The portion that did not become the surface layer becomes the inner layer. The activation step can be performed by repeating a predetermined cycle. In one cycle, the following (Step 1) to (Step 5) are sequentially performed.
(Step 1) A step of discharging the battery at a current value of 5 lt at 50° C. for 2.4 minutes (discharging 20% of the capacity) and then pausing for 10 minutes is repeated four times. Here, It is a current value represented by It (A)=rated capacity (Ah)/1 (h).
(Step 2) The battery is placed at 50° C. for 3 h.
(Step 3) The battery is placed at 20° C. for 6 h.
(Step 4) At 20° C., the battery is charged with an amount of electricity corresponding to 100% capacity at a current value of 0.1 lt.
(Step 5) The battery is placed at 20° C. for 3 h.

In the activation step described above, in the step 1, Mg in the negative electrode can be dissolved in the electrolytic solution by a decrease in pH on the surface of the negative electrode due to a temperature increase and rapid discharge. In the step 2, Mg ions in the electrolyte may be diffused into the two surface layers of the positive electrode. In the step 3, the Mg ions diffused into the two surface layers can be precipitated as a Mg compound. The temperature in the step 1 and the step 2 is preferably in the range of 50° C. to 80° C. The temperature in step 3 is preferably 30° C. or less. The lower the temperature is, the more easily the Mg compound is precipitated.

The number of repetitions of the cycle may be changed as appropriate. The thickness of the surface layer can be changed by the number of repetitions. As described above, the positive electrode including the two surface layers and the inner layer described above can be formed. Thus, the alkaline storage battery (B) is obtained.

The alkaline storage battery (B) contains a nickel compound as a positive electrode active material and a hydrogen storage alloy as a negative electrode active material. The exemplary alkaline storage battery (B) can be referred to as a nickel-metal hydride storage battery. Examples of the configuration and constituent elements of the alkaline storage battery (B) will be described below. However, the configuration and constituent elements of the alkaline storage battery (B) are not limited to the following examples. Known components used in alkaline storage batteries (for example, nickel-metal hydride storage batteries) may be applied to the components other than the positive electrode mixture layer.

The alkaline storage battery (B) includes an exterior body, and an electrode group and an alkaline electrolyte solution housed in the exterior body. The form of the electrode group is not limited, and may be a wound body or a form other than a wound body (for example, a stacking body). The electrode group of the wound body is formed by winding the positive electrode, the negative electrode, and the separator such that the separator is disposed between the positive electrode and the negative electrode. The electrode group of the stacking body is formed by stacking the positive electrode, the negative electrode, and the separator such that the separator is disposed between the positive electrode and the negative electrode. The shape of the alkaline storage battery (B) is not limited, and may be a cylindrical shape, a rectangular shape, or a button shape (including a coin shape).

### (Positive Electrode)

The positive electrode includes a positive electrode mixture layer containing a positive electrode active material. The positive electrode may include a positive electrode current collector and a positive electrode mixture layer supported by the positive electrode current collector.

The positive electrode current collector is not particularly limited, and a known positive electrode current collector may be used. Examples of the positive electrode current collector include a porous current collector formed of a metal (such as nickel or a nickel alloy). Specifically, examples of the positive electrode current collector include foamed nickel and a sintered nickel plate.

The positive electrode mixture layer contains a positive electrode active material and the above-described compound. The positive electrode mixture layer contains other components (such as a conductive material, a binder, and a thickener) as necessary. As the positive electrode active material, particles of a nickel compound having a surface at least partially coated with a cobalt compound can be used. As the nickel compound, nickel hydroxide can be used, and a part of the nickel hydroxide may be turned into nickel oxyhydroxide. The nickel compound may be at least one selected from the group consisting of nickel hydroxide and nickel oxyhydroxide.

Examples of the cobalt compound covering at least a part of the surface of the nickel compound particle include cobalt hydroxide, γ-cobalt oxyhydroxide, and β-cobalt oxyhydroxide.

Hereinafter, the nickel compound having a surface at least partially coated with a cobalt compound may be referred to as a “Co-coated nickel compound”. Co-coated nickel compound particles have been conventionally used as a positive electrode active material for alkaline storage batteries. Therefore, a known positive electrode active material may be used as the positive electrode active material.

The proportion of the Co-coated nickel compound in the positive electrode mixture layer may be 80% by mass or more (for example, 90% by mass or more). The proportion of the Co compound in the Co-coated nickel compound may be in the range of 2 mass % to 20 mass % (for example, in the range of 3 mass % to 15 mass %).

The content of the positive electrode active material in the surface layer may be substantially the same as the content of the positive electrode active material in the inner layer. The content of the positive electrode active material in the surface layer may be in the range of 0.9 to 1.1 times (for example, in the range of 0.95 to 1.05 times) the content of the positive electrode active material in the inner layer.

The method for coating the surface of the nickel compound particle with the Co compound is not particularly limited, and a known method may be used. The coating may be performed by attaching a dispersion liquid containing a Co compound to the surface of the nickel compound particles and drying the dispersion liquid. Alternatively, the coating may be performed by a mechanochemical method.

The conductive material is not particularly limited, and a known conductive material may be used. Examples of the conductive material include conductive fibers (such as metal fibers), metal particles (such as nickel particles and cobalt particles), and conductive carbon materials (such as graphite and carbon black). These conductive materials may be used alone or in combination of two or more. As the conductive material, a conductive cobalt compound (e.g., cobalt hydroxide and γ-type cobalt oxyhydroxide) may be used.

The amount of the conductive material may be in the range of 0.01 to 20 parts by mass (for example, in the range of 0.1 to 10 parts by mass) relative to 100 parts by mass of the positive electrode active material.

The binder is not particularly limited, and a known binder used for alkaline storage batteries may be used. Examples of the binder include rubber materials such as styrene-butadiene copolymer rubber; polyolefin resins such as polyethylene and polypropylene; fluororesins such as polyvinylidene fluoride; acrylic resins such as ethylene-acrylic acid copolymers and ethylene-methyl acrylate copolymers, and Na ion-crosslinked products thereof. These binders may be used alone or in combination of two or more. The amount of the binder may be 7 parts by mass or less, or may be in the range of 0.01 to 5 parts by mass, relative to 100 parts by mass of the positive electrode active material.

Examples of the thickener include cellulose derivatives such as carboxymethyl cellulose and modified products thereof (including salts such as Na salts and ammonium salts), and methyl cellulose; saponified products of polymer having vinyl acetate unit such as polyvinyl alcohol; and polyalkylene oxides such as polyethylene oxide. These thickeners may be used alone or in combination of two or more. The amount of the thickener may be 5 parts by mass or less, or may be in the range of 0.01 to 3 parts by mass, relative to 100 parts by mass of the positive electrode active material.

The positive electrode can be formed by attaching a positive electrode mixture containing a positive electrode active material to a positive electrode current collector. In the production of the positive electrode, the positive electrode mixture is usually used in the form of a paste containing a dispersion medium. In an example of the method for producing a positive electrode, first, a positive electrode paste containing a positive electrode active material is prepared. Next, the positive electrode paste is applied to or filled in the positive electrode current collector, and then dried and rolled. In this manner, the positive electrode including the positive electrode current collector and the positive electrode mixture layer supported by the positive electrode current collector can be produced.

The amount of the predetermined element in the positive electrode can be determined from the mass of the material used in the production of the positive electrode. The amount of the predetermined element in the positive electrode assembled into the battery can be determined using an electron probe microanalyzer (hereinafter, referred to as EPMA). Specifically, first, a positive electrode to be measured is embedded in an epoxy resin and cut so that a cross section of the positive electrode appears, thereby preparing a sample for cross-sectional observation. The sample is analyzed with an electron probe microanalyzer (EPMA) at an acceleration voltage of 15 keV and an irradiation current of 5×10⁻⁸ A to obtain a mapping image of Mg at a magnification of 100 times. The level of the mapping image is adjusted to clarify the density of Mg. In the region where the concentration of Mg is high, the magnification is adjusted in the range of 1,000 to 2,000 times, and mapping images of Ni and Co are observed. The position of Co coated with a nickel compound (such as nickel hydroxide) is specified from the mapping image, and the mass ratio of Ti, Mg, and Co is measured in the range where the coated Co is present. Next, the mass ratios of Ti and Mg to Co are determined from the obtained results. Similarly to the above-described elemental analysis method, the mass ratios of Ti, Yb, Y, Nb, W, Mg, and Co can be measured in the range in which the coated Co is present. From the obtained results, the weight ratio of each element to the Co element can be determined.

### (Negative Electrode)

The negative electrode is not particularly limited, except that the negative electrode includes a negative electrode mixture layer containing a hydrogen storage alloy (negative electrode active material). Constituent elements other than the negative electrode active material may be constituent elements of the negative electrode used in known nickel-metal hydride storage batteries.

The negative electrode may include a negative electrode current collector and a negative electrode mixture layer supported by the negative electrode current collector. The negative electrode current collector is not limited, and a known negative electrode current collector may be used. Examples of the negative electrode current collector include porous or non-porous sheets formed of metal (e.g., stainless steel, nickel, and nickel alloy).

The negative electrode can be formed by attaching a negative electrode mixture containing a negative electrode active material to a negative electrode current collector. In the production of the negative electrode, the negative electrode mixture is usually used in the form of a paste containing a dispersion medium. In an example of the method for producing a negative electrode, first, a negative electrode paste containing a powder of a hydrogen storage alloy is prepared. Next, the negative electrode paste is applied to or filled in the negative electrode current collector, and then dried and rolled. In this manner, the negative electrode including the negative electrode current collector and the negative electrode mixture layer supported by the negative electrode current collector can be produced.

The negative electrode mixture may contain components other than the negative electrode active material (such as a conductive material, a binder, and a thickener) as necessary. The dispersion medium, the conductive material, the binder, and the thickener may be the same as those exemplified for the positive electrode.

### (Alkaline Electrolyte)

As the alkaline electrolyte, an aqueous solution containing an alkaline solute can be used. Examples of the solute include alkali metal hydroxides, and specific examples thereof include lithium hydroxide, potassium hydroxide, and sodium hydroxide. The solute may be used singly or in combination of two or more kinds thereof.

The concentration of the solute (specifically, alkali metal hydroxide) contained in the alkaline electrolyte may be in the range of 2.5 to 13 mol/L (for example, 3 to 12 mol/L). The specific gravity of the alkaline electrolyte may be in the range of 1.1 to 1.6 (e.g. in the range of 1.2 to 1.5). The alkaline electrolyte preferably contains potassium hydroxide. The alkaline electrolyte may contain potassium hydroxide and another alkali metal hydroxide (lithium hydroxide and/or sodium hydroxide).

### (Separator)

The separator is not particularly limited, and a known separator used for an alkaline storage battery (for example, a nickel-metal hydride storage battery) may be used. Examples of the form of the separator include a microporous membrane, a nonwoven fabric, and a woven fabric. The separator can be formed of an insulating material. Examples of the material of the separator include polyolefin resins (e.g. polyethylene and polypropylene), fluororesins, and polyamide resins.

### (Others)

Constituent elements other than those described above (such as an exterior body and a lead) are not particularly limited, and known constituent elements used for alkaline storage batteries (for example, nickel-metal hydride storage batteries) may be used. When the alkaline storage battery (B) is a cylindrical battery, an example of the exterior body includes a bottomed cylindrical battery case, a sealing body that seal the battery case, and a gasket.

Hereinafter, an example of the present embodiment will be specifically described with reference to the drawings. The constituent elements described above can be applied to the constituent elements of the exemplary embodiment described below. The constituent elements of the exemplary embodiments described below can be changed based on the above description. Further, the matters described below may be applied to the above-described embodiment. In an exemplary embodiment described below, constituent elements that are not essential for the alkaline storage battery according to the present disclosure may be omitted.

### Embodiment

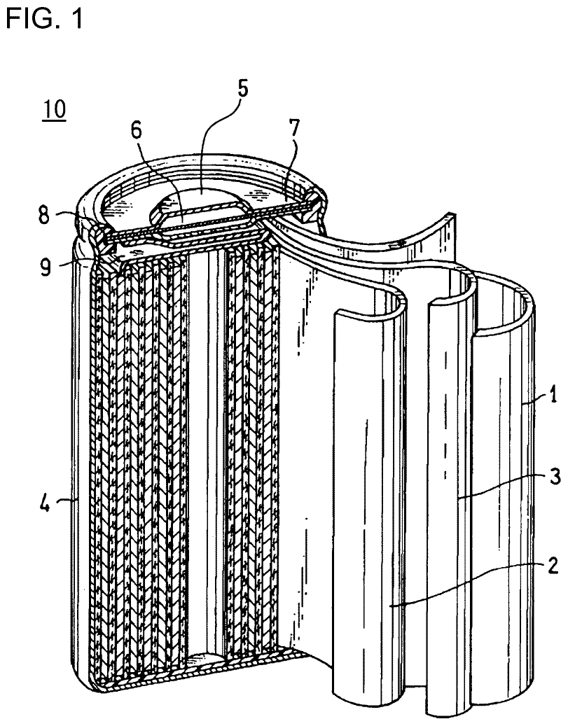

In the embodiment, an example of a cylindrical nickel-metal hydride storage battery will be described as an example of the alkaline storage battery (B). FIG. 1 is a partially exploded perspective view schematically illustrating a structure of an alkaline storage battery 10 according to the embodiment. The alkaline storage battery 10 includes a battery case 4, and an electrode group and an alkaline electrolyte (not shown) housed in battery case 4. The battery case 4 is a bottomed cylindrical case. The electrode group is formed by winding a negative electrode 1, a positive electrode 2, and a separator 3 such that the separator 3 is disposed between the negative electrode 1 and the positive electrode 2. The opening of the battery case 4 is sealed with a sealing body 7 and an insulating gasket 8. The sealing body 7 includes a positive electrode terminal 5 and a safety valve 6. The positive electrode 2 and the sealing body 7 are electrically connected to each other via a positive electrode current collector plate 9. The battery case 4 is electrically connected to the negative electrode 1 and functions as a negative electrode terminal. The positive electrode 2 is the positive electrode described above.

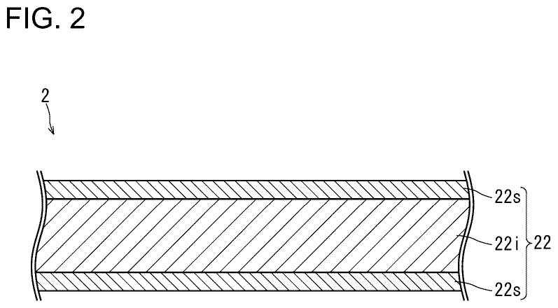

A cross-sectional view of the positive electrode 2 is schematically shown in FIG. 2. The positive electrode 2 includes a positive electrode current collector (not shown) and a positive electrode mixture layer 22 held by the positive electrode current collector. The positive electrode mixture layer 22 includes two surface layers 22s and an inner layer 22i sandwiched between the two surface layers 22s. Each layer satisfies the conditions described above.

### Notes

The following techniques are disclosed by the above description of the embodiments.

### (Technique 1)

An alkaline storage battery, comprising:
a positive electrode including a positive electrode mixture layer containing, as a positive electrode active material, a nickel compound having a surface at least partially coated with a cobalt compound; and
a negative electrode including a negative electrode mixture layer containing a hydrogen storage alloy,
wherein
the positive electrode mixture layer includes two surface layers and an inner layer sandwiched between the two surface layers,
each of the two surface layers and the inner layer contains the positive electrode active material,
a thickness Ts of each of the two surface layers is 20 μm or more,
a ratio Ts/Tp of the thickness Ts to a thickness Tp of the positive electrode mixture layer is in a range of 0.03 to 0.20,
each of the two surface layers contains a titanium compound and a magnesium compound,
the inner layer contains a compound of at least one element X selected from the group consisting of Ti, Yb, Y, Nb, and W,
a ratio Mst/Msc of a mass Mst of titanium contained in each of the two surface layers to a mass Msc of cobalt contained in each of the two surface layers is in a range of 0.04 to 0.60,
a ratio Msm/Msc of a mass Msm of magnesium contained in each of the two surface layers to the mass Msc is in a range of 0.01 to 0.30,
a ratio Mix/Mic of a total mass Mix of the at least one element X contained in the inner layer to a mass Mic of cobalt contained in the inner layer is in a range of 0.04 to 0.60, and
a ratio Mim/Mic of a mass Mim of magnesium contained in the inner layer to the mass Mic is 0.001 or less.

### (Technique 2)

The alkaline storage battery according to Technique 1, wherein the ratio Ts/Tp is 0.10 or less.

### (Technique 3)

The alkaline storage battery according to Technique 1 or 2, wherein the two surface layers contains a hydroxide of at least one element selected from the group consisting of Ca and Ba.

### (Technique 4)

The alkaline storage battery according to any one of Techniques 1 to 3, wherein the two surface layers includes a compound of at least one element Z selected from the group consisting of W, Yb, Y, and Nb.

### (Technique 5)

The alkaline storage battery according to any one of Techniques 1 to 4, wherein the hydrogen storage alloy has an equilibrium hydrogen pressure of 0.15 MPa or less at 45° C.

### EXAMPLES

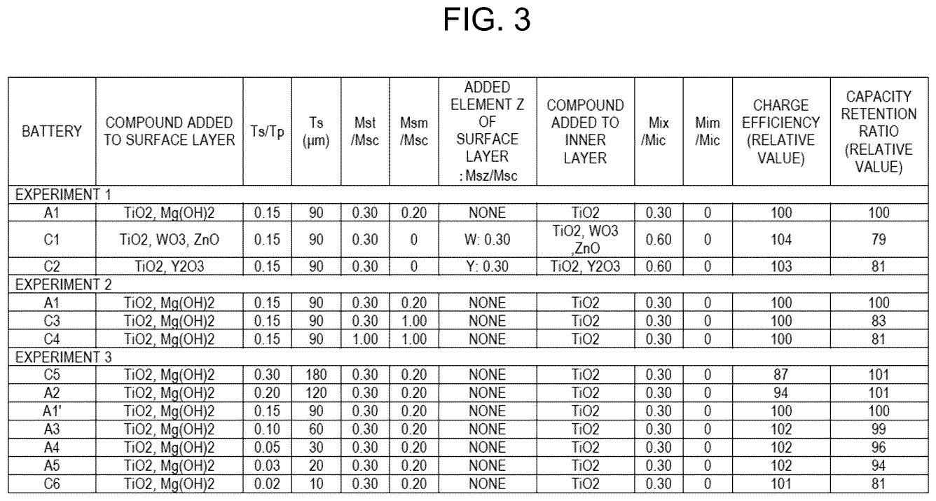

Hereinafter, the present disclosure will be described in more detail by the examples. In the following examples, a plurality of alkaline storage batteries (nickel-metal hydride storage batteries) were produced and evaluated. FIGS. 3 to 10 are tables showing evaluation results of the alkaline storage batteries according to the embodiment.

### (Experiment 1)

In the experiment 1, a plurality of types of alkaline storage batteries were produced by changing the positive electrode. Specifically, an alkaline storage battery (battery A1) having a structure similar to the structure shown in FIG. 1 was produced by the following procedure.

### (Preparation of Battery A1)

### (1) Preparation of Positive Electrode

A positive electrode PA1 was fabricated by the method described in the above-described production method (PM1). Specifically, first, nickel hydroxide powder was added to an aqueous cobalt sulfate solution to obtain a mixture. The obtained mixture, an aqueous ammonia solution, and an aqueous sodium hydroxide solution were supplied to a reactor at respective predetermined supply rates and mixed under stirring. Thus, the surface of the nickel hydroxide powder (100 parts by mass) was coated with cobalt hydroxide (5 parts by mass). Next, the coated nickel hydroxide powder was heated in the presence of an aqueous NaOH solution at 90° C. to 130° C. while air (oxygen) is supplied, thereby converting the cobalt hydroxide into a conductive cobalt oxide. Thus, a positive electrode active material (nickel hydroxide powder coated with cobalt oxide) was obtained. Next, a second paste was prepared by mixing the positive electrode active material, titanium oxide powder, magnesium hydroxide powder, carboxymethyl cellulose (hereinafter, referred to as CMC), and pure water. The second paste was applied to a current collector (foamed nickel) and then dried to form a second sheet.

Next, a first sheet was formed under the same conditions as in the method for forming the second sheet, except that magnesium hydroxide was not added. Next, one second sheet was disposed between two first sheets and pressed to obtain a positive electrode sheet. The positive electrode sheet was cut into a predetermined size to obtain a positive electrode PA1. The portion of the first sheet became the two surface layers and the portion of the second sheet became the inner layer. The first and second sheets were prepared so that the content of the positive electrode active material, the density of the positive electrode mixture, and the density of the current collector in the first sheet were the same as those in the second sheet. The thicknesses and pressing were adjusted so that the thickness of the two surface layers and the thickness of the positive electrode mixture layer were as shown in FIG. 3.

### (2) Preparation of Negative Electrode

A mixture was obtained by mixing 100 parts by mass of the hydrogen storage alloy powder, 0.2 parts by mass of carboxymethyl cellulose (thickener), 0.2 parts by mass of Ketjen black (conductive material), and 0.5 parts by mass of styrene-butadiene rubber (binder). As the hydrogen storage alloy, a hydrogen storage alloy containing La, Ni, Co, Mn, and Al was used. The equilibrium hydrogen pressure of the hydrogen storage alloy was 0.05 MPa when the hydrogen storage amount H/M was 0.5 at 45° C. Water was added to the obtained mixture and further mixed to prepare a negative electrode paste.

Next, the negative electrode paste was applied to both surfaces of the negative electrode current collector to form coating films. A nickel-plated iron punching metal was used as the negative electrode current collector. The obtained coating films were dried and then pressed together with the negative electrode current collector to form a negative electrode mixture layer. The negative electrode mixture layer was formed to have substantially constant thickness over the entire negative electrode. Next, the sheet including the negative electrode current collector and the negative electrode mixture layer was cut into a predetermined size to obtain a negative electrode.

### (3) Preparation of Alkaline Storage Battery

The produced positive electrode, the negative electrode, and the separator were wound to produce a wound body (electrode group). As the separator, a nonwoven fabric made of sulfonated polypropylene was used.

Next, the wound body and an alkaline electrolyte solution were housed in a battery case. As the alkaline electrolyte, an electrolyte having an alkali metal hydroxide concentration of 5.5 mol/L was used. As the alkali metal hydroxide, KOH, NaOH, and LiOH were mixed at KOH:NaOH:LiOH=2:7:1 (molar ratio) and used.

Next, the opening of the battery case was sealed with the gasket and the sealing body. At this time, the foamed nickel porous body (positive electrode current collector) and the sealing body (positive electrode terminal) were electrically connected via a connecting member. The negative electrode and the battery case (negative electrode terminal) were electrically connected to each other via a connecting member. Thus, an alkaline storage battery (battery A1) having a rated capacity of 1200 mAh was produced.

### (Preparation of Other Batteries)

Batteries C1-C2 were produced in the same manner and under the same conditions as in the production of Battery A1, except that the compounds contained in the two surface layers and in the inner layer were changed as shown in FIG. 3. In the production of the positive electrode of the battery C1, the mass of Ti and the mass of W in the inner layer were the same as each other. In the production of the positive electrode of the battery C2, the mass of Ti and the mass of Y in the inner layer were the same as each other.

### (Charging Efficiency)

The charging efficiency of the produced battery was evaluated by the following method. First, in an environment of 20° C., the battery was charged at a current value of 0.1 lt for 16 hours, then left in an environment of 20° C. for 3 hours, and then discharged at a current value of 0.2 lt in an environment of 20° C. until the battery voltage reached 1 V. Such charge and discharge were repeated two cycles, and the discharge capacity E (20) at the second cycle was determined. In addition, the discharge capacity E (85) at the second cycle was determined by the same method except that the battery temperature during charging was changed to 85° C. The charging efficiency (%) at a high temperature was determined from the following equation. The higher the charging efficiency, the better the battery characteristics at high temperature.

$$Charging efficiency ( \% ) = 100 \times E ( 85 ) / E ( 20 )$$

### (High-Temperature Storage Characteristics)

The high-temperature storage characteristics of the produced battery were evaluated by the following method. First, in an environment of 20° C., the battery was preliminarily discharged at a current value of 0.2 lt until the battery voltage reached 1 V. Next, the battery was charged at a current value of 0.1 lt for 16 hours, and then discharged at a current value of 0.2 lt until the battery voltage reached 1 V. At this time, the discharge capacity CO when the battery was discharged at the current value of 0.2 lt was measured.

Next, the battery was charged in an environment of 20° C. at a current value of 0.1 lt for 16 hours. Next, a cycle of storing the battery in an environment at 85° C. for 20 hours and then charging the battery at a current value of 0.1 lt for 4 hours was repeated for 3 months.

Next, in an environment of 20° C., the battery was preliminarily discharged at a current value of 0.2 lt until the battery voltage reached 1 V. Next, the battery was charged at a current value of 0.1 lt for 16 hours, and then discharged at a current value of 0.2 lt until the battery voltage reached 1 V. At this time, the discharge capacity C1 when the battery was discharged at the current value of 0.2 lt was measured. Then, the capacity retention ratio was obtained from the following equation. A higher capacity retention ratio indicates better battery characteristics at high temperatures.

$$Capacity retention ratio ( \% ) = 100 \times C 1 / C 0$$

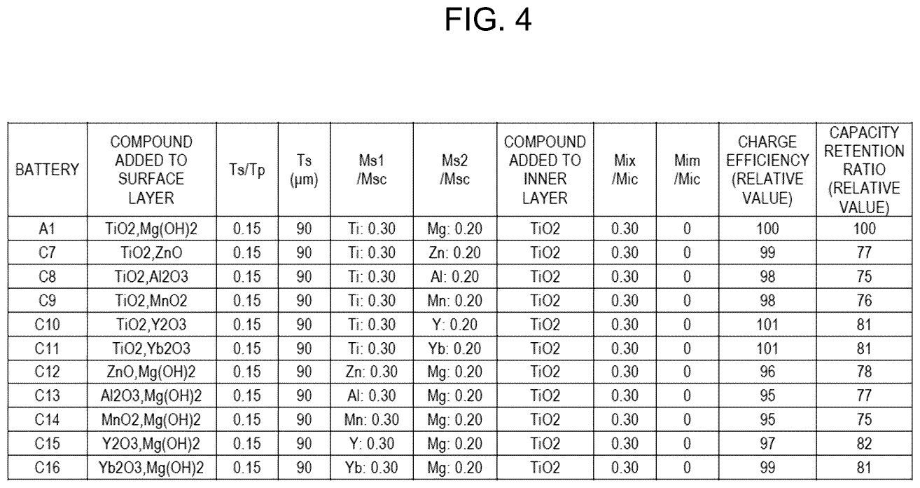

A part of the production conditions of the positive electrode and the evaluation results are shown in FIG. 3. In the experiments 1 and 2 of FIG. 3, the charge efficiency and the capacity retention ratio are shown as relative values when the evaluation result of the battery A1 is 100. Also in FIGS. 4 to 8, unless otherwise specified, the charge efficiency and the capacity retention ratio are shown by using relative values when the evaluation result of the battery A1 is set to 100. In the experiment 3 of FIG. 3, the charge efficiency and the capacity retention ratio are shown as relative values when the evaluation result of the battery A1′ is 100. In FIG. 3, the subscripts indicating the ratios of the elements and atomic groups in the compounds are represented by standard numbers for the sake of clarity. For example, “TiO₂” in FIG. 3 represents “TiO₂” (the same applies to FIGS. 4 to 8).

The battery A1 is an alkaline storage battery (B) according to the present disclosure. The batteries C1 and C2 are comparative examples. As shown in FIG. 3, the battery A1 had higher battery characteristics at high temperatures than the batteries C1 and C2.

### (Experiment 2)

Batteries C3 and C4 of the comparative examples were produced in the same manner and under the same conditions as in the production of the battery A1, except that the production conditions of the positive electrode were changed as shown in FIG. 3. The produced batteries were evaluated in the same manner as in the experiment 1. As shown in FIG. 3, the battery A1 had higher battery characteristics at high temperatures than the batteries C3 and C4.

### (Experiment 3)

Batteries A1′ to A5 and C₅ to C₆ were produced by changing the production conditions of the positive electrode as shown in FIG. 3. However, each battery was manufactured by the method described in the production method (BM2) described above. The batteries A1′ to A5 are alkaline storage batteries (B) according to the present disclosure. The batteries C5 and C6 are comparative examples. The produced batteries were evaluated in the same manner as in the experiment 1. As shown in FIG. 3, the battery A1 had higher battery characteristics at high temperatures than the batteries C5 and C6.

### (Experiment 4)

Batteries C7 to C16 of the comparative examples were produced by the same method and under the same conditions as in the production of the battery A1, except that the production conditions of the positive electrode were changed as shown in FIG. 3. The produced batteries were evaluated in the same manner as in the experiment 1.

A part of the production conditions and the evaluation results are shown in FIG. 4. Ms1/Msc is the ratio of the mass Ms1 of the element 1 (see FIG. 4) contained in the surface layer to the mass Msc of cobalt contained in the surface layer. Similarly, Ms2/Msc is the ratio of the mass Ms2 of the element 2 (see FIG. 4) contained in the surface layer to the mass Msc of cobalt contained in the surface layer. As shown in FIG. 4, the battery A1 had higher battery characteristics at high temperatures than the batteries C7 to C16.

### (Experiment 5)

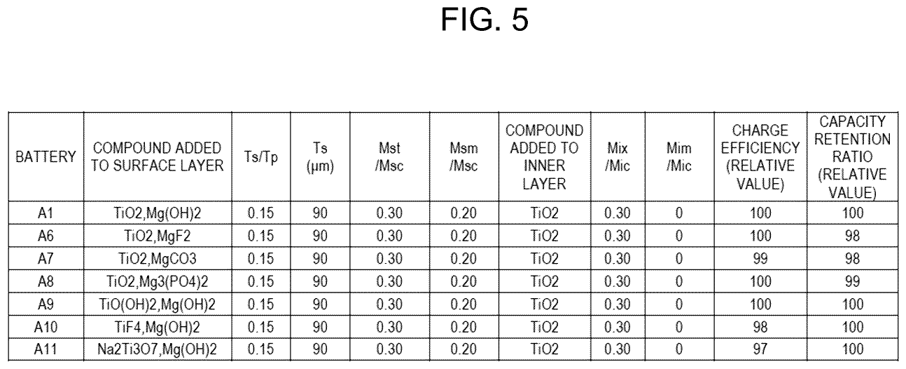

Batteries A6 to A11 were produced in the same manner and under the same conditions as in the production of the battery A1, except that the production conditions of the positive electrode were changed as shown in FIG. 5. The batteries A6 to A11 are alkaline storage batteries (B) according to the present disclosure. The produced batteries were evaluated in the same manner as in the experiment 1. As shown in FIG. 5, all the batteries according to the present disclosure had high battery characteristics at high temperatures.

### (Experiment 6)

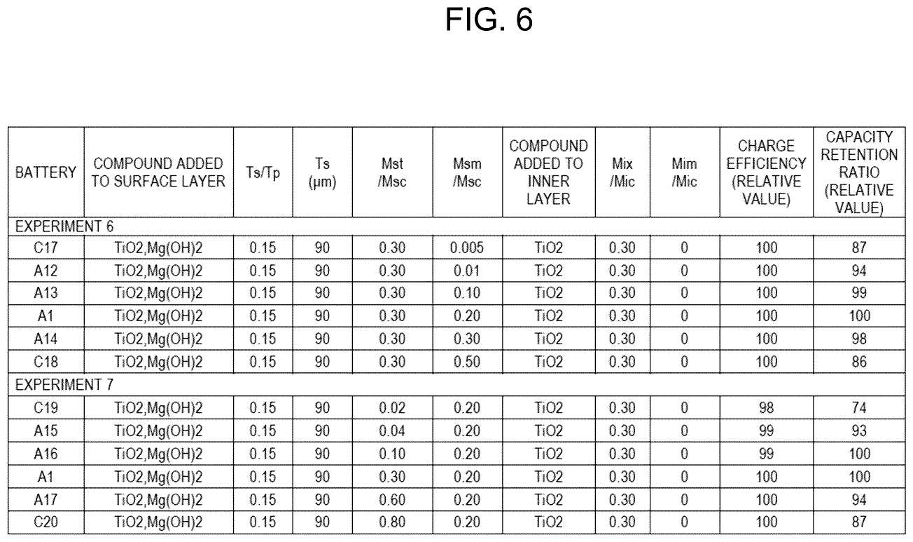

Batteries A12 to A14 according to the present disclosure and batteries C17 and C18 of the comparative example were produced by the same method and under the same conditions as in the production of the battery A1, except that the production conditions of the positive electrode were changed as shown in FIG. 6. The produced batteries were evaluated in the same manner as in the experiment 1. As shown in FIG. 6, the batteries according to the present disclosure had higher battery characteristics at high temperatures than the batteries of the comparative example.

### (Experiment 7)

Batteries A15 to A17 according to the present disclosure and batteries C19 and C20 of the comparative example were produced by the same method and under the same conditions as in the production of the battery A1, except that the production conditions of the positive electrode were changed as shown in FIG. 6. The produced batteries were evaluated in the same manner as in the experiment 1. As shown in FIG. 6, the batteries according to the present disclosure had higher battery characteristics at high temperatures than the batteries of the comparative example.

### (Experiments 8 to 10)

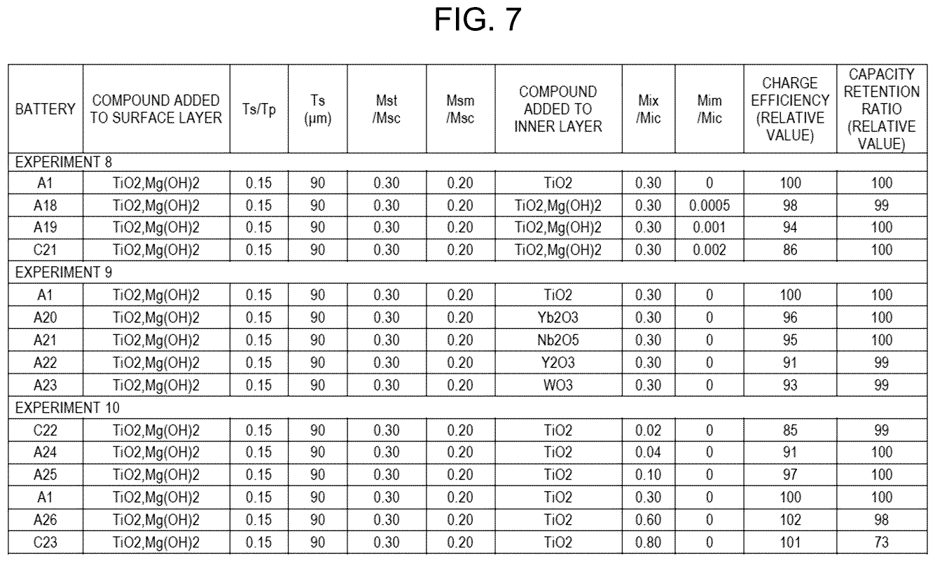

Batteries A18 to A26 according to the present disclosure and batteries C21 to C23 of the comparative example were produced by the same method and under the same conditions as in the production of the battery A1, except that the production conditions of the positive electrode were changed as shown in FIG. 7. The produced batteries were evaluated in the same manner as in the experiment 1. As shown in FIG. 7, the batteries according to the present disclosure had higher battery characteristics at high temperatures than the batteries of the comparative example.

### (Experiment 11)

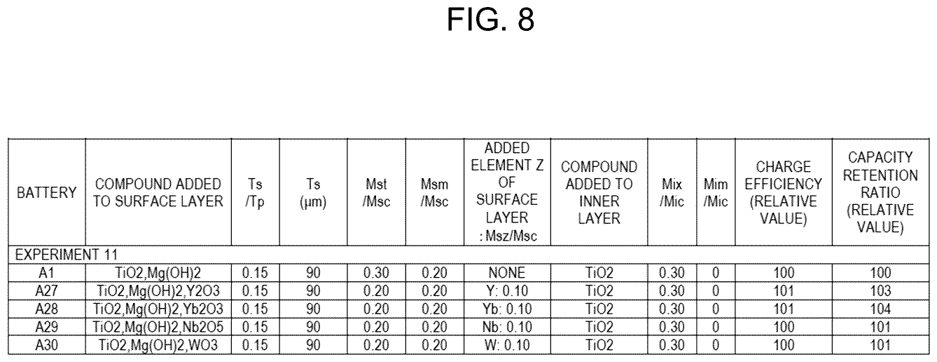

Batteries A27 to A30 according to the present disclosure were produced by the same method and under the same conditions as in the production of the battery A1, except that the production conditions of the positive electrode were changed as shown in FIG. 8. The produced batteries were evaluated in the same manner as in the experiment 1. As shown in FIG. 8, the batteries according to the present disclosure had high battery characteristics at high temperature.

### (Experiment 12)

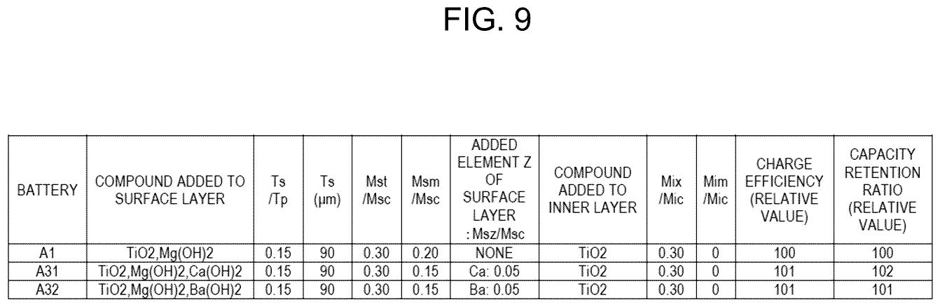

Batteries A31 and A32 according to the present disclosure were produced by the same method and under the same conditions as in the production of the battery A1, except that the production conditions of the positive electrode were changed as shown in FIG. 9. The produced batteries were evaluated in the same manner as in the experiment 1. As shown in FIG. 9, by adding a predetermined element to the two surface layers, the battery characteristics at a high temperature were particularly improved.

### (Experiment 13)

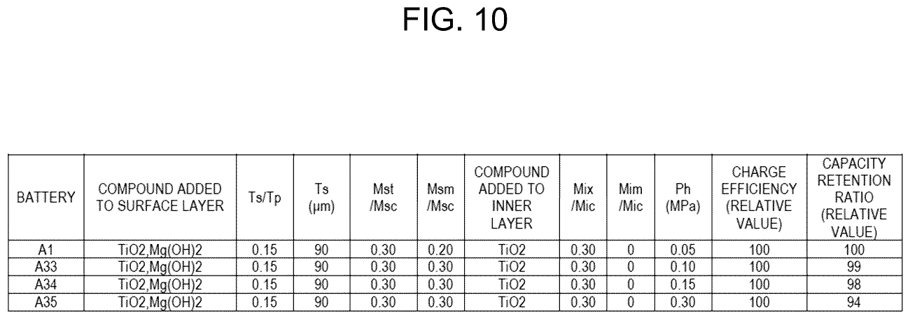

Batteries A33 to A35 according to the present disclosure were produced by the same method and under the same conditions as in the production of the battery A1, except that the hydrogen storage alloy used in the production of the negative electrode was changed. As the hydrogen storage alloy, a hydrogen storage alloy having an equilibrium hydrogen pressure Ph shown in FIG. 10 when the hydrogen storage amount H/M=0.5 at 45° C. was used. The produced batteries were evaluated in the same manner as in the experiment 1. A part of the manufacturing conditions and the evaluation results are shown in FIG. 10.

As shown in FIG. 10, by setting the equilibrium hydrogen pressure Ph to be 0.15 MPa or less, the battery characteristics at a high temperature were particularly improved.

### INDUSTRIAL APPLICABILITY

The present disclosure is applicable to an alkaline storage battery (for example, a nickel-metal hydride storage battery).

### REFERENCE SIGNS LIST

1 negative electrode
2 positive electrode
3 separator
4 battery case
7 sealing body
8 insulating gasket
10 alkaline storage battery
22 positive electrode mixture layer
22i inner layer
22s surface layer

1. An alkaline storage battery, comprising:
a positive electrode including a positive electrode mixture layer containing, as a positive electrode active material, a nickel compound having a surface at least partially coated with a cobalt compound; and
a negative electrode including a negative electrode mixture layer containing a hydrogen storage alloy,
wherein
the positive electrode mixture layer includes two surface layers and an inner layer sandwiched between the two surface layers,
each of the two surface layers and the inner layer contains the positive electrode active material,
a thickness Ts of each of the two surface layers is 20 μm or more,
a ratio Ts/Tp of the thickness Ts to a thickness Tp of the positive electrode mixture layer is in a range of 0.03 to 0.20,
each of the two surface layers contains a titanium compound and a magnesium compound, the inner layer contains a compound of at least one element X selected from the group consisting of Ti, Yb, Y, Nb, and W,
a ratio Mst/Msc of a mass Mst of titanium contained in each of the two surface layers to a mass Msc of cobalt contained in each of the two surface layers is in a range of 0.04 to 0.60,
a ratio Msm/Msc of a mass Msm of magnesium contained in each of the two surface layers to the mass Msc is in a range of 0.01 to 0.30,
a ratio Mix/Mic of a total mass Mix of the at least one element X contained in the inner layer to a mass Mic of cobalt contained in the inner layer is in a range of 0.04 to 0.60, and
a ratio Mim/Mic of a mass Mim of magnesium contained in the inner layer to the mass Mic is 0.001 or less.

2. The alkaline storage battery according to claim 1, wherein
the ratio Ts/Tp is 0.10 or less.

3. The alkaline storage battery according to claim 1, wherein
the two surface layers contain a hydroxide of at least one element selected from the group consisting of Ca and Ba.

4. The alkaline storage battery according to claim 1, wherein
the two surface layers contain a compound of at least one element Z selected from the group consisting of W, Yb, Y, and Nb.

5. The alkaline storage battery according to claim 1, wherein
the hydrogen storage alloy has an equilibrium hydrogen pressure of 0.15 MPa or less at 45° C.
